(19) United States
(12) Patent Application Publication
(10) Pub. No.: US 2012/0076366 A1
(43) Pub. Date: Mar. 29, 2012

(54) SYSTEM AND METHOD FOR BIOMETRIC IDENTIFICATION

(75) Inventors: Gary Nelson Garcia Molina, Eindhoven (NL); Vojkan Mihajlovic, Eindhoven (NL); Ivo Johannes Maria Erkens, Eindhoven (NL); Sri Andari Husen, Eindhoven (NL)

(73) Assignee: KONINKLIJKE PHILIPS ELECTRONICS N.V., EINDHOVEN (NL)

(21) Appl. No.: 13/375,609

(22) PCT Filed: Jun. 7, 2010
(86) PCT No.: PCT/IB10/52512

§ 371 Date: Dec. 1, 2011

(30) Foreign Application Priority Data
Jun. 12, 2009 (EP) 09162584.8

(51) Int. Cl. G06K 9/00

(52) U.S. Cl. 382/117

(57) ABSTRACT

A system (10) is provided for enabling biometric identification. The system (10) comprises at least two electrodes (12), a database (14) and a processor (13). The at least two electrodes (12) are to be applied to a face of a subject for capturing electrophysiological signals (51, 52, 53, 54) therefrom. The subject is one of the registered users. The database (14) comprises characteristic eye blink data of registered users. The processor (13) is operably coupled to the electrodes (12) and the database (14) and is operative to receive the electrophysiological signals (51, 52, 53, 54) from the at least two electrodes (12) during at least one eye blink of the subject, to derive eye blink characteristics from the obtained electrophysiological signals (51, 52, 53 54), to make a comparison of the derived eye blink characteristics with at least part of the characteristic eye blink data in the database (14) and to determine an identity of the subject, based on the comparison.

### FIELD OF THE INVENTION

This invention relates to a system for biometric identification, a device, a method and a computer program product for biometric identification.

### BACKGROUND OF THE INVENTION

A biometric identification system is described in United States patent application US 2008/0104415 A1. In that patent application, an apparatus is described for recognizing a subject based on biometric features. The apparatus first selects at least one stimulus from a database and provides the stimulus to the subject. Then the device uses at least one sensor to acquire a response of the subject to the stimulus. The response is analyzed and compared to pre-stored subject specific identification templates for recognizing the object. The acquired responses may be physical, physiological or behavioral. Three sub systems for detecting the responses are described in patent application US 2008/0104415. One sub system uses a video camera. Another sub system uses electro-oculography. The last sub system uses photo detectors for measuring light reflected from the eye. All three described sub systems are operative to track eye movements. By comparing a user's eye movements following one or more selected stimuli to the subject specific information, the identity of the user is determined.

One of the disadvantages of the system of US 2008/0104415 is that specific and controlled stimuli have to be provided to the user. This is not only disadvantage because the system requires dedicated stimulus providing means, but also because it the providing of the stimulus the detection of the response are separate processes during which the user cannot do anything else.

### SUMMARY OF THE INVENTION

It is desirable to provide an easier to use biometric identification system. According to a first aspect of the invention, this object is achieved by providing a system for biometric identification, the system comprising at least two electrodes, a database and a processor. The at least two electrodes are to be applied to a face of a subject for capturing electrophysio logical signals therefrom. The database is provided for comprising characteristic eye blink data of registered users. The processor is operably coupled to the electrodes and the database. The processor is operative to receive the electrophysiological signals from the at least two electrodes during at least one eye blink of the subject, the subject being one of the registered users, to derive eye blink characteristics from the obtained electrophysio logical signals, to make a comparison of the derived eye blink characteristics with at least part of the characteristic eye blink data in the database and to determine an identity of the subject, based on the comparison.

Eye blinking is an essential function of the eye that irrigates and removes irritants from the surface of the cornea. Several characteristics of the electrophysio logical signals obtained from the at least two electrodes and representing one or more eye blinks are user specific. Therefore, the comparison of the acquired eye blink characteristics with data in the database can be used for identification. Eye blink characteristics are independent of provided stimuli. It is an advantage of the system according to the invention, that no stimuli are required for performing the biometric identification. An adult person blinks, on average, 10 times a minute. Without supplying any stimulus, the system will still receive plenty of data for performing the biometric identification. The absence of stimulus providing means makes the system smaller and cheaper. The subject being identified is not hindered by any artificial stimulus needed for the identification. The system according to the invention thus is very easy to use and minimizes the amount of time and the effort the subject has to bear for being identified.

Preferably, the electrodes are integrated in one measurement device. For example, the measurement device may be a headgear with two or more integrated electrodes or a frame against which the subject may place his head in order to enable the capturing of the required electrophysiological signals. Such measurement devices make it unnecessary to attach the multiple electrodes at correct positions on the users head separately. The measurement device is preferably shaped in such a way that the electrodes are automatically positioned correctly.

According to a second aspect of the invention, a method is provided for biometric identification. The method comprises the steps of receiving the electrophysio logical signals from at least two electrodes being applied to a face of a subject during at least one eye blink of the subject, deriving eye blink characteristics from the obtained electrophysio logical signals, making a comparison of the derived eye blink characteristics with characteristic eye blink data of registered users, the subject being one of the registered users, and based on the comparison, determining an identity of the subject.

According to a further aspect of the invention, a computer program product is provided for performing the above described method.

These and other aspects of the invention are apparent from and will be elucidated with reference to the embodiments described hereinafter.

### BRIEF DESCRIPTION OF THE DRAWINGS

In the drawings:

FIG. 1 schematically shows the system according to the invention,

FIG. 2 shows averaged eye blinking signals from four different subjects,

FIG. 3 shows multiple eye blinking signals for four different subjects,

FIG. 4 shows a frame based embodiment of the system according to the invention,

FIG. 5 shows a helmet based embodiment of the system according to the invention, and

FIG. 6 shows a flow diagram of the method according to the invention.

### DETAILED DESCRIPTION OF THE INVENTION

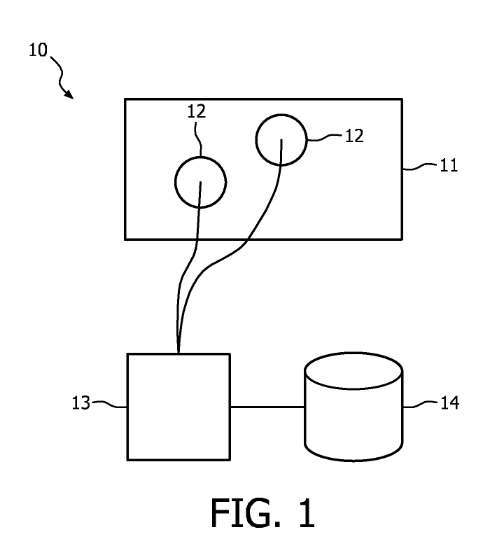

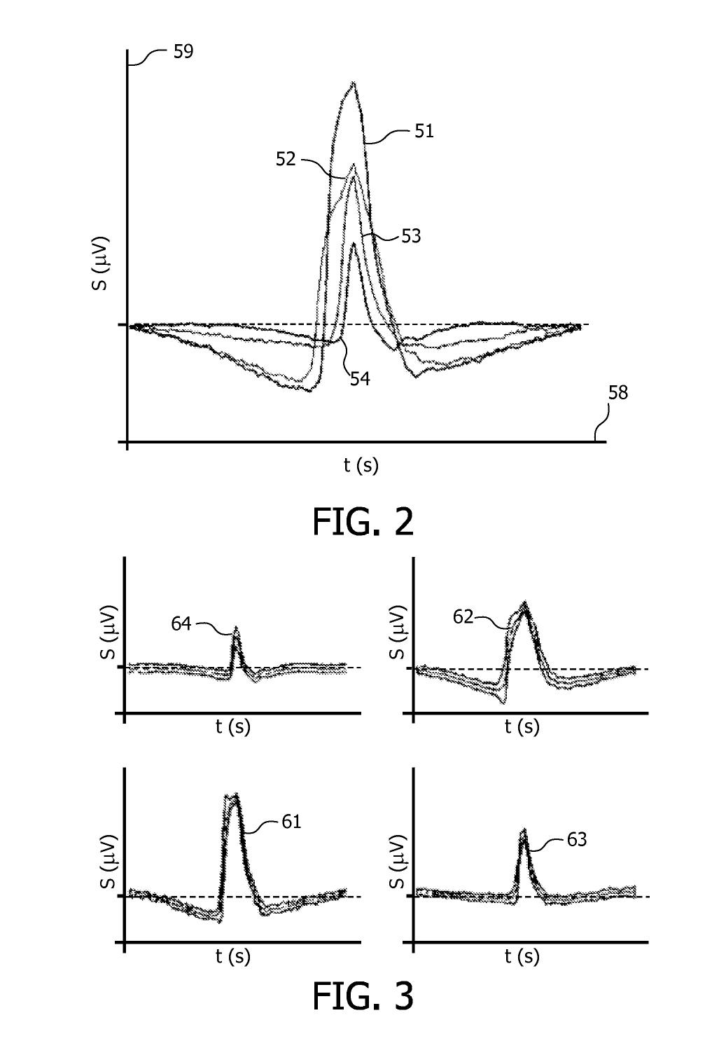

FIG. 1 schematically shows the system 10 according to the invention. The system 10 comprises two electrodes 12 which are applied to a head 11 of a subject. Preferably, one of the electrodes 12 is positioned on the front of the forehead while the other one is attached to the left or right side of the face between the ear and the eye. Further electrodes 12 may be used for recording additional signals and improving the reliability of the system 10. The electrodes 12 are arranged for picking up electrophysiological signals from the subject's skin. When the electrodes 12 are applied to suitable positions on the subject's forehead 11, the picked up electrophysiological signals comprise information concerning eye blinks of the subject. In FIG. 1, the electrophysiological signals are sent to a processor 13 via wired connections. Alternatively, the signals may be sent to the processor 13 using wireless communication. The processor 13 receives the electrophysiological signals and derives eye blink characteristics from the signals. Some exemplary electrophysiological signals 51, 52, 53, 54, 61, 62, 63, 64 are shown in FIGS. 2 and 3. It is apparent from FIGS. 2 and 3 that the peaks and other morphological features, such as peak-width or valley amplitude, in the electrophysiological signals that are caused by eye blinks of the subject are easily recognizable by the processor 13.

FIG. 2 shows averaged eye blink signals 51, 52, 53, 54 from four different subjects. The signals 51, 52, 53, 54 are plotted in an X-Y graph wherein the recorded values from the electrodes 12 in micro-Volts (y-axis 59) are shown as a function of time in seconds (x-axis 58). Each signal shown in FIG. 2 represents the shape of an eye blink signal for one subject, averaged over multiple eye blinks. From FIG. 2 it is clear that the eye blink signals 51, 52, 53, 54 of different subjects have different characteristic properties. The signals from different subjects, e.g., differ in shape, peak height and peak width. These differences between signals from different subjects make the eye blink signals very suitable for biometric identification.

FIG. 3 shows multiple eye blinking signals 61, 62, 63, 64 for four different subjects. While FIG. 2 shows the significant differences between eye blink signals of different subjects, FIG. 3 shows that different eye blink signals 61, 62, 63, 64 of the same subject closely resemble one another. Consequently, it is not necessary to obtain signals from many eye blinks for reliably identifying a subject. It may even be sufficient to process a signal representing one eye blink only.

The database 14 is coupled to the processor 13. The database 14 or part of the database 14 and the processor 13 may be part of a single device. Alternatively, the database 14 may be provided as a separate unit, coupled to the processor via a wired or wireless connection. The database 14 and the processor 13 may be part of a closed network or the database may be available via wide area networks like the Internet. If the processor 13 and the database 14 are coupled via a wide area network, it is preferable to encrypt the data flow between the database 14 and the processor 13.

The database 14 comprises characteristic eye blink data of registered users. The processor compares the eye blink characteristics derived from the captured eye blink signals to the data in the database. The comparison may, e.g., be based on peak height and/or peak width. Preferably a morphological comparison is made between the captured signals and signals stored in the database 14. Depending on the application for which the biometric identification is used, a required matching level may be defined. For very critical application for which it is very important that no unauthorized person is granted access to the system, the required matching level should be very high (i.e. the false acceptance rate must be low). For less critical applications, the required matching level may be lower. If the required matching level is high, the system 10 may be designed to use an averaged signal representing a larger number of eye blinks to improve the reliability of the system 10.

If the captured eye blink signals match the stored data for one of the registered users in the database 14, the subject is recognized. When a subject is recognized, the captured electrophysio logical signals may be used for updating the characteristic eye blink data of the respective user in the database 14. If the subject is not recognized, the system may provide the option to register the unknown user and to store the captured signals as the characteristic data for the newly registered user.

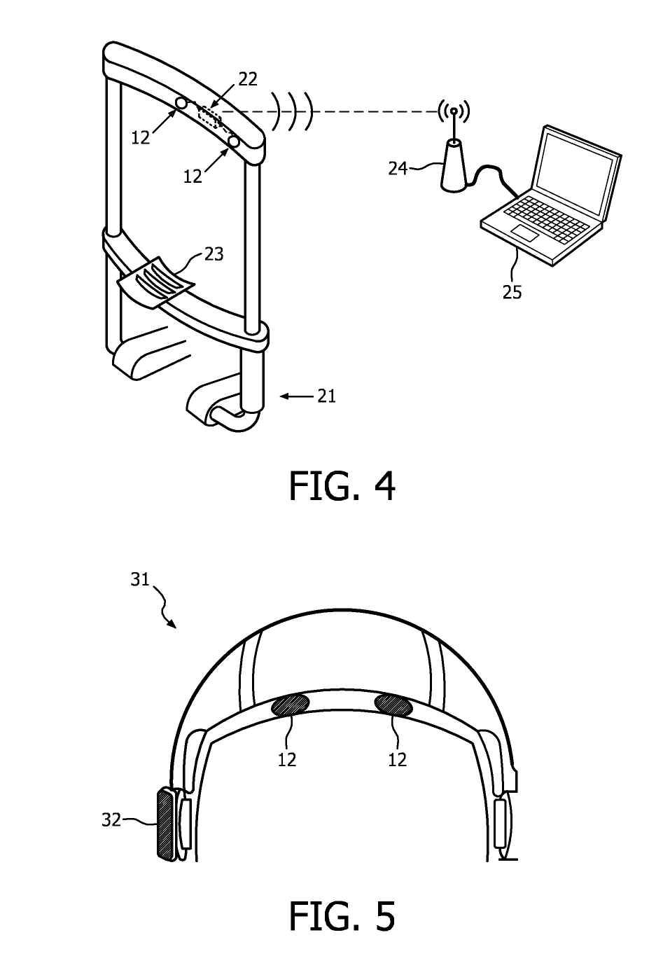

FIG. 4 shows a frame based embodiment 21 of the system according to the invention. This embodiment may, e.g., be used for deciding to grant a subject access to a certain room. The frame 21 may be installed next to a closed door. When the subject places his face against the frame 21, with his chin on the chin support 23, the electrodes 12 make contact with skin on the forehead of the user. The electrophysio logical signal captured by the electrodes 12 during at least one eye blink are sent to a nearby receiver 24 by a transmitter 22 integrated in the frame 21. The receiver is coupled to a computer 25 which comprises the processor 13 for comparing the captured data to the stored data. The stored eye blink characteristics may be in a database 14 comprised in the computer 25. Alternatively, the computer 25 is coupled to the database 14 via a local or wide area network. If the subject is recognized as an authorized person, the door is unlocked or opened.

FIG. 5 shows a helmet based embodiment 31 of the system according to the invention. This helmet 31 may, e.g., be used in computer games or virtual reality applications. The helmet 31 comprises two or more electrodes 12 which make contact with the forehead of the subject when the helmet is worn and used for biometric identification. The processor 13 and the database 14 may be comprised in one or more electronics compartments 32 in the helmet 31. Preferably, the helmet 31 only comprises a transmitter or transmitter/receiver for sending the captured electrophysiological signals to a nearby computer with a receiver. The electronics compartment 32 may further comprise a battery for powering the electrodes, the transmitter or other electronic equipment.

In other embodiments, the electrodes may, e.g., be integrated in a pair of glasses or a headband.

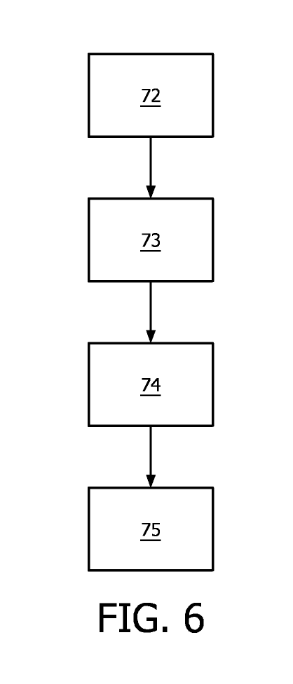

FIG. 6 shows a flow diagram of the method according to the invention. The figure shows a four step method. As already elucidated above with reference to the other Figures, the method may comprise optional further steps. The steps shown in FIG. 6 are a receiving step 72 for receiving the electrophysiological signals from the at least two electrodes during at least one eye blink of the subject, a feature obtaining step 73 for deriving eye blink characteristics from the obtained electrophysiological signals, a comparison step 74 for making a comparison of the derived eye blink characteristics with at least part of the characteristic eye blink data in the database, and a identification step 75 for, based on the comparison, determining an identity of the subject.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system (10) for biometric identification, the system (10) comprising:
at least two electrodes (12) for being applied to a face of a subject for capturing electrophysiological signals (51, 52, 53, 54) therefrom,
a database (14) comprising characteristic eye blink data of registered users,
a processor (13) operably coupled to the electrodes (12) and the database (14), the processor (13) being operative to:
receive the electrophysiological signals (51, 52, 53, 54) from the at least two electrodes (12) during at least one eye blink of the subject, the subject being one of the registered users,
derive eye blink characteristics from the obtained electrophysiological signals (51, 52, 53 54),
make a comparison of the derived eye blink characteristics with at least part of the characteristic eye blink data in the database (14),
based on the comparison, determine an identity of the subject.

2. A system (10) for biometric identification as claimed in claim 1, wherein the comparison comprises a morphological comparison.

3. A system (10) for biometric identification as claimed in claim 1, wherein the at least two electrodes (12) are comprised in one measurement device (21, 31).

4. A system (10) for biometric identification as claimed in claim 3, wherein the measurement device is a headgear (31).

5. A system (10) for biometric identification as claimed in claim 4, wherein the headgear (31) is a pair of glasses or a headband.

6. A system (10) for biometric identification as claimed in claim 3, wherein the measurement device (21, 31) further comprises a transmitter (22) for sending the captured electrophysiological signals (51, 52, 53, 54) to a receiver (24), the receiver (24) being coupled to the processor (13).

7. A device (25) for performing biometric identification, the device (25) comprising a processor (13), the processor being operative to:
receive electrophysiological signals (51, 52, 53, 54) from at least two electrodes (12) being applied to a face of a subject during at least one eye blink of the subject,
derive eye blink characteristics from the obtained electrophysiological signals (51, 52, 53 54),
make a comparison of the derived eye blink characteristics with characteristic eye blink data in a database (14) comprising eye blink data of registered users,
based on the comparison, determine an identity of the subject.

8. A method for biometric identification, the method comprising the steps of:
receiving (72) electrophysiological signals (51, 52, 53, 54) from at least two electrodes (12) being applied to a face of a subject during at least one eye blink of the subject,
deriving (73) eye blink characteristics from the obtained electrophysiological signals (51, 52, 53, 54),
making (74) a comparison of the derived eye blink characteristics with characteristic eye blink data of registered users, the subject being one of the registered users, and
based on the comparison, determining (75) an identity of the subject.

9. A computer program product, which program is operative to cause a processor to perform a method as claimed in claim 8.
